(19) United States
(12) Patent Application Publication
(10) Pub. No.: US 2026/0278683 A1
(43) Pub. Date: Sep. 17, 2026

(54) HARDWARE-ATTESTED TRADE INTEGRITY SYSTEM FOR PREDICTION MARKETS

(71) Applicant: George William Bickerstaff, III, Greenwich, CT (US)

(72) Inventor: George William Bickerstaff, III, Greenwich, CT (US)

(21) Appl. No.: 19/679,707

(22) Filed: May 17, 2026

(51) Int. Cl. G06Q 40/04

(52) U.S. Cl. CPC G06Q 40/043; G06Q 2220/00

(57) ABSTRACT

Conventional prediction-market surveillance and contract resolution rely on software-only systems that operators can modify and that regulators cannot independently verify. The disclosed platform addresses this through three combined mechanisms: hardware-attested surveillance, deterministic regulator re-execution, and a hardware-attested resolution oracle. Order-flow and account-metadata records are ingested over encrypted channels terminating inside a hardware trusted execution environment. Surveillance classifications are cryptographically bound in hardware-attestation quotes tying together code measurement, input commitment, parameter commitment, and output. A tamper-evident Merkle-accumulator audit ledger anchors its root to a publicly verifiable data registry. A resolution oracle operating in its own TEE produces hardware-attested settlement finality without an optimistic-oracle dispute window. A regulator may instantiate an independent TEE, load the same certified code, verify the input commitments, re-execute the surveillance computation, and obtain bit-identical confirmation; divergence is recorded under attestation.

### CROSS-REFERENCE TO RELATED APPLICATIONS

This non-provisional patent application is filed under 35 U.S.C. § 111(a) and 37 C.F.R. § 1.53(b) and claims the benefit of priority under 35 U.S.C. § 119(e) and 37 C.F.R. § 1.78 to U.S. Provisional Patent Application No. 64/043,908, filed 20 Apr. 2026, naming George William Bickerstaff, III as the sole inventor. The twelve-month priority period under 35 U.S.C. § 119(e)(1) expires 20 Apr. 2027, and this application is filed within that period. The entire disclosure of the foregoing provisional application is incorporated herein by reference.

This application is also related to co-pending provisional applications of the same inventor filed in April 2026, including provisional applications directed to influence forecasting and risk engines, reinforcement-learning-based adaptive influence engines, decentralized stakeholder voting layers, artificial-intelligence reputation oracles, and hardware-anchored post-quantum artificial-intelligence lifecycle attestation. The entire disclosures of those co-pending provisional applications are incorporated herein by reference for descriptive context. No claim of priority benefit under 35 U.S.C. § 120 or § 121 is asserted in this non-provisional application to any application other than U.S. Provisional Patent Application No. 64/043,908, the subject matter claimed herein being independently supported by the disclosure of that provisional application.

### STATEMENT REGARDING FEDERALLY SPONSORED RESEARCH OR DEVELOPMENT

Not applicable. The invention was developed solely with private funds of the inventor.

### REFERENCE TO SEQUENCE LISTING, TABLE, OR COMPUTER PROGRAM LISTING APPENDIX

Not applicable.

### FIELD OF THE INVENTION

The present invention relates to regulated electronic trading infrastructure. More particularly, it relates to hardware-attested trade integrity, surveillance, audit, regulatory-reporting, and contract-resolution systems for prediction market exchanges operating under designated contract market, registered exchange, or equivalent regulatory frameworks. The disclosed subject matter combines hardware-rooted trusted execution environment technology, remote attestation infrastructure, cryptographic graph analysis for account-linkage detection, tamper-evident audit ledgers, and deterministic regulator re-execution.

### BACKGROUND OF THE INVENTION

Three technical problems motivate the invention. They are described below, followed by a brief explanation of why existing systems do not solve them in combination.

### Untrusted Software—Only Surveillance

Prediction market exchanges have transitioned from retail-oriented venues to regulated financial-market infrastructure carrying institutional capital. Designated Contract Market status under the United States Commodity Exchange Act imposes surveillance obligations comparable to those imposed on traditional derivatives exchanges, including detection of wash trading, spoofing, layering, marking-the-close, coordinated manipulative patterns, and trading on undisclosed non-public information. Conventional prediction-market surveillance infrastructure relies on software-only audit databases modifiable by the exchange operator, manual compliance review that does not scale to institutional order volumes, and reporting workflows that depend on representations of the regulated party. Conventional systems do not provide cryptographic evidence, sealed at the hardware level and attested remotely by a hardware vendor independent of the exchange, that a given surveillance finding was computed on the correct inputs using the certified surveillance code base without operator intervention.

### Optimistic Oracle Dispute Risk

Existing prediction market platforms commonly rely on software-based optimistic-oracle architectures for contract resolution. A declared outcome becomes final only if no challenge is asserted within a configured dispute window. These architectures assume economic rationality of dispute participants, expose resolved markets to retroactive manipulation claims, and undermine settlement finality. As prediction-market exchanges list contracts whose notional exposure approaches that of traditional derivatives markets, the optimistic-oracle model becomes operationally and legally untenable. Existing architectures do not provide hardware-attested resolution outcomes binding the resolution result to a measured resolution-oracle code base, to cryptographic commitments over the input data sources, and to a deterministic resolution rule committed at contract listing.

### Lack of Independent Regulator Verification

Mature regulated markets require that a regulator verify surveillance findings independently of the regulated party. Conventional prediction-market and even traditional-derivatives surveillance architectures do not provide a mechanism by which a regulator can independently re-execute the certified surveillance code base on the certified inputs and obtain bit-identical confirmation of the regulated party's findings. Audit trails are produced by the regulated party's software, exported in formats whose integrity depends on the regulated party's representations, and verified, if at all, by manual sampling. Existing systems do not enable a regulator to instantiate an independent trusted execution environment, load the same measured surveillance code base, supply sealed input commitments, and obtain a cryptographic guarantee that the regulated party's findings are exactly those produced by the certified code on the certified inputs.

### Composite Problem

Conventional systems do not provide the integrated combination of hardware-attested surveillance, hardware-attested contract resolution, and deterministic regulator re-execution in a single platform. Hardware trusted execution environments provide isolated execution but do not produce domain-specific surveillance findings for prediction-market venues. Cryptographic graph-analysis libraries provide linkage-detection primitives but do not tie analysis outputs to hardware attestation of the executing code base. Tamper-evident ledgers record arbitrary data but do not bind recorded entries to surveillance findings produced inside a measured TEE. Optimistic-oracle frameworks provide a fallback dispute mechanism but do not produce hardware-attested resolution finality. What is needed, and what the present invention provides, is an integrated platform in which the validity of every surveillance finding depends on a hardware-rooted measurement of an authorized TEE; the validity of every audit ledger entry depends on a hardware-attestation quote binding it; the validity of every contract resolution depends on hardware attestation of the resolution-oracle code base and committed inputs; and the validity of every regulator export depends on the regulator's ability to re-execute the certified code in an independent TEE and obtain bit-identical confirmation.

### SUMMARY OF THE INVENTION

This summary introduces concepts further described below. It does not identify essential features and does not limit the scope of the claimed subject matter.

The invention provides a hardware-attested trade integrity system for prediction market exchanges. The system performs surveillance, audit, regulatory reporting, contract resolution, and regulator verification inside one or more hardware trusted execution environments (TEEs). Code bases executing inside each TEE are measured by hardware. Each surveillance classification and each resolution outcome is cryptographically bound in a hardware-attestation quote that ties together the code-base measurement, a commitment over the input records, a commitment over the surveillance parameters, and the produced output. No classification is admissible as a regulator-verifiable record unless the output was produced by the measured code base executing within an authorized TEE on records ingested over encrypted channels terminating within that TEE, and is cryptographically bound in a hardware-attestation quote independently verifiable against a hardware-vendor attestation service.

In one aspect, the platform comprises one or more hardware TEEs, an order-intake interface, an account-metadata interface, a linkage-analysis module, a surveillance module, an attestation module, a tamper-evident audit ledger implemented as a Merkle accumulator with periodic public root commitments, and a regulatory-export interface configured to support submission under 17 C.F.R. Parts 16, 17, and 45 and equivalent foreign regulatory frameworks.

In further aspects, the platform includes a hardware-attested resolution-outcome subsystem that replaces software-based optimistic-oracle architectures with hardware-anchored settlement finality, a deterministic regulator re-execution mechanism by which a regulator instantiates an independent TEE and verifies bit-identical equivalence between regulator-computed classifications and exchange-produced classifications, a divergence-record mechanism that records non-equivalence under attestation, cross-exchange attestation aggregation for jurisdiction-wide linkage detection, and selective disclosure with zero-knowledge proofs.

### BRIEF DESCRIPTION OF THE DRAWINGS

Five figures, each comprising five subfigures, illustrate embodiments of the invention. Identical reference numerals denote identical or analogous elements throughout. The following table identifies each figure and subfigure. The paragraphs that follow provide the technical description.

| FIG. | TITLE | DESCRIPTION |
|---|---|---|
| FIG. 1 | SYSTEM | OVERALL PLATFORM SHOWING TEE, |
| | ARCHITECTURE | INGEST INTERFACES, SURVEILLANCE |
| | | MODULES, ATTESTATION, AND AUDIT |
| | | LEDGER. |
| FIG. 1A | TEE SYSTEM | HARDWARE TEE (110) WITH MEASURED |
| | OVERVIEW | SURVEILLANCE CODE BASE LOADED FROM |
| | | A VENDOR-SIGNED IMAGE. |
| FIG. 1B | ORDER INTAKE | ORDER-INTAKE INTERFACE (120) |
| | | DELIVERING ORDER-FLOW RECORDS OVER |
| | | ENCRYPTED CHANNEL TO TEE. |
| FIG. 1C | METADATA INTAKE | ACCOUNT-METADATA INTERFACE (125) |
| | | DELIVERING KYC, AML, GEOLOCATION, |
| | | AND DEVICE-ATTESTATION DATA. |
| FIG. 1D | INTERNAL MODULES | LINKAGE-ANALYSIS (130), SURVEILLANCE |
| | | (140), AND ATTESTATION (150) MODULES |
| | | EXECUTING WITHIN TEE. |
| FIG. 1E | EXTERNAL | AUDIT LEDGER (160) AND REGULATORY- |
| | INTERFACES | EXPORT INTERFACE (170) RECEIVING |
| | | HARDWARE-SIGNED WRITES. |
| FIG. 2 | SURVEILLANCE | WORKFLOW FROM CODE LOAD THROUGH |
| | WORKFLOW | INGESTION, ANALYSIS, CLASSIFICATION, |
| | | AND ATTESTED EXPORT. |
| FIG. 2A | CODE LOAD | LOADING AND MEASUREMENT OF |
| | | SURVEILLANCE CODE BASE INSIDE |
| | | HARDWARE TEE (110). |
| FIG. 2B | INPUT INGESTION | INGESTION OF ORDER-FLOW AND |
| | | ACCOUNT-METADATA RECORDS OVER |
| | | ENCRYPTED CHANNELS TERMINATING IN |
| | | TEE. |
| FIG. 2C | LINKAGE | COMPUTATION OF CRYPTOGRAPHIC |
| | FINGERPRINTS | ACCOUNT-LINKAGE FINGERPRINTS WITHIN |
| | | TEE. |
| FIG. 2D | PATTERN | CLASSIFICATION OF TRADE PATTERNS AS |
| | CLASSIFICATION | WASH-TRADING, COORDINATED-TRADING, |
| | | OR COLLUSION INDICATORS. |
| FIG. 2E | ATTESTATION QUOTE | PRODUCTION OF HARDWARE- |
| | | ATTESTATION QUOTE BINDING CODE |
| | | MEASUREMENT, INPUTS, PARAMETERS, |
| | | AND CLASSIFICATIONS. |
| FIG. 3 | LINKAGE ANALYSIS | ACCOUNT-LINKAGE FINGERPRINT |
| | | COMPUTATION, PAIRWISE SCORING, AND |
| | | GROUPING DETECTION. |
| FIG. 3A | FEATURE VECTOR | FEATURE VECTOR COMBINING HASHED |
| | | FUNDING SOURCE, IP GEOLOCATION, |
| | | DEVICE, TEMPORAL, AND CO-MOVEMENT |
| | | FEATURES. |
| FIG. 3B | PAIRWISE SCORING | COMPUTATION OF WEIGHTED JACCARD |
| | | SIMILARITIES AND MUTUAL-INFORMATION |
| | | ESTIMATES FOR EACH ACCOUNT PAIR. |
| FIG. 3C | GROUPING | CONNECTED-COMPONENT, LOUVAIN, AND |
| | DETECTION | DENSITY-BASED GROUPING OF ACCOUNTS |
| | | EXCEEDING LINKAGE THRESHOLD. |
| FIG. 3D | WASH TRADE | DETECTION OF ROUND-TRIP |
| | DETECTION | TRANSACTIONS WITH BELOW-THRESHOLD |
| | | NET POSITION CHANGE ACROSS |
| | | GROUPING. |
| FIG. 3E | COLLUSION | DETECTION OF TEMPORALLY- |
| | DETECTION | CORRELATED ORDER PATTERNS AND |
| | | COORDINATED RESPONSE TO TRIGGER |
| | | EVENTS. |
| FIG. 4 | AUDIT LEDGER | MERKLE-ACCUMULATOR AUDIT LEDGER |
| | | WITH PERIODIC PUBLIC ROOT |
| | | COMMITMENT AND REGULATORY EXPORT. |
| FIG. 4A | MERKLE | APPEND-ONLY MERKLE ACCUMULATOR |
| | ACCUMULATOR | (160) RECEIVING HARDWARE-SIGNED |
| | | WRITES FROM TEE. |
| FIG. 4B | PUBLIC | PERIODIC COMMITMENT OF MERKLE ROOT |
| | COMMITMENT | (162) TO PUBLICLY VERIFIABLE DATA |
| | | REGISTRY (164). |
| FIG. 4C | SELECTIVE | INCLUSION PROOFS FOR DISCLOSED |
| | DISCLOSURE | RECORDS AGAINST PREVIOUSLY |
| | | COMMITTED MERKLE ROOTS. |
| FIG. 4D | REGULATORY | EXPORT INTERFACE (170) PRODUCING 17 |
| | EXPORT | CFR PART 16/17/45 OR EQUIVALENT |
| | | REPORTING RECORDS. |
| FIG. 4E | ZK PROOF EXPORT | ZERO-KNOWLEDGE PROOF (180) |
| | | DEMONSTRATING SURVEILLANCE |
| | | INTEGRITY WITHOUT PLAINTEXT |
| | | DISCLOSURE. |
| FIG. 5 | RESOLUTION AND | HARDWARE-ATTESTED RESOLUTION, |
| | VERIFICATION | CROSS-EXCHANGE AGGREGATION, |
| | | REGULATOR RE-EXECUTION, AND |
| | | DIVERGENCE. |
| FIG. 5A | RESOLUTION ORACLE | RESOLUTION-ORACLE TEE (200) INGESTING |
| | | DESIGNATED INPUT SOURCES AT |
| | | RESOLUTION EVENT. |
| FIG. 5B | RESOLUTION | ATTESTATION QUOTE BINDING |
| | ATTESTATION | RESOLUTION OUTCOME TO ORACLE |
| | | MEASUREMENT, INPUTS, AND |
| | | DETERMINISTIC RULE. |
| FIG. 5C | CROSS-EXCHANGE | ATTESTATION AGGREGATOR (300) |
| | AGGREGATION | RECEIVING QUOTES FROM MULTIPLE |
| | | EXCHANGES FOR CROSS-VENUE LINKAGE. |
| FIG. 5D | REGULATOR RE- | INDEPENDENT TEE (400) LOADING |
| | EXECUTION | MEASURED CODE BASE AND RE- |
| | | EXECUTING ON SEALED INPUT |
| | | COMMITMENTS. |
| FIG. 5E | DIVERGENCE | DIVERGENCE RECORD (410) BINDING |
| | RECORD | RECEIVED AND REGULATOR-COMPUTED |
| | | CLASSIFICATIONS UNDER ATTESTATION. |

FIG. 1 illustrates the SYSTEM ARCHITECTURE. FIG. 1A depicts the TEE system overview, including hardware Trusted Execution Environment (110) with a measured surveillance code base loaded from a vendor-signed image. FIG. 1B depicts the order intake, including Order-Intake Interface (120) delivering order-flow records over an encrypted channel terminating within the TEE. FIG. 1C depicts the metadata intake, including Account-Metadata Interface (125) delivering KYC, AML, geolocation, and device-attestation data over encrypted channels. FIG. 1D depicts the internal modules, including Linkage-Analysis Module (130), Surveillance Module (140), and Attestation Module (150), each executing entirely within Trusted Execution Environment (110). FIG. 1E depicts the external interfaces, including Tamper-Evident Audit Ledger (160) and Regulatory-Export Interface (170) receiving hardware-signed writes from the TEE.

FIG. 2 illustrates the SURVEILLANCE WORKFLOW. FIG. 2A depicts the code load, in which the surveillance code base is loaded into the TEE and measured by hardware. FIG. 2B depicts the input ingestion of order-flow and account-metadata records over encrypted channels terminating within the TEE. FIG. 2C depicts the computation by Linkage-Analysis Module (130) of cryptographic account-linkage fingerprints. FIG. 2D depicts the classification by Surveillance Module (140) of trade patterns. FIG. 2E depicts the production by Attestation Module (150) of a hardware-attestation quote (152) binding code measurement, input commitment, parameter commitment, and classifications.

FIG. 3 illustrates LINKAGE ANALYSIS. FIG. 3A depicts the feature vector combining hashed funding-source identifiers, settlement-counterparty identifiers, internet-protocol geolocation prefixes, device-attestation identifiers, temporal-pattern vectors, and co-movement vectors. FIG. 3B depicts pairwise scoring using weighted Jaccard similarities, mutual-information estimates, and supervised-classifier scores. FIG. 3C depicts grouping detection using connected-component analysis, Louvain modularity optimization, or density-based clustering. FIG. 3D depicts wash-trade detection of round-trip transaction sequences with sub-threshold net position change across a grouping. FIG. 3E depicts collusion detection of temporally-correlated order-submission patterns and coordinated response to trigger events.

FIG. 4 illustrates the AUDIT LEDGER. FIG. 4A depicts a Merkle accumulator implementation of Tamper-Evident Audit Ledger (160) receiving hardware-signed writes. FIG. 4B depicts periodic public commitment of Merkle Root (162) to Publicly Verifiable Data Registry (164). FIG. 4C depicts selective disclosure using inclusion proofs against previously committed Merkle roots. FIG. 4D depicts the regulatory export by Regulatory-Export Interface (170) producing reporting records configured to support submission under 17 C.F.R. Part 16, Part 17, and Part 45, SEC Rule 613 of Regulation NMS, and equivalent foreign regulatory schemas. FIG. 4E depicts the zero-knowledge proof export of Zero-Knowledge Proof (180) demonstrating surveillance integrity without disclosure of plaintext records.

FIG. 5 illustrates RESOLUTION AND VERIFICATION. FIG. 5A depicts Resolution-Oracle TEE (200) ingesting designated input data sources at a resolution event. FIG. 5B depicts the resolution attestation quote binding the Resolution Outcome to the resolution-oracle code measurement, the input commitments, and the deterministic resolution rule. FIG. 5C depicts cross-exchange aggregation by Attestation Aggregator (300) receiving attestation quotes from multiple exchanges. FIG. 5D depicts regulator re-execution by independent TEE (400) loading the measured code base and re-executing on sealed input commitments. FIG. 5E depicts Divergence Record (410) binding received and regulator-computed classifications under attestation.

### DETAILED DESCRIPTION OF THE INVENTION

Reference is made to the accompanying drawings, which form a part hereof and show by way of illustration specific embodiments. These embodiments are described in sufficient detail to enable a person of ordinary skill in the art to practice the invention. Other embodiments may be utilized and logical, mechanical, electrical, and procedural changes may be made without departing from the scope of the invention. The scope of the invention is defined by the appended claims as properly interpreted.

### Definitions

For purposes of this disclosure, the following terms, listed in alphabetical order, have the meanings set forth below. The definitions are non-limiting and are provided to aid in claim interpretation. Each term is to be given its broadest reasonable interpretation consistent with the specification.

“Account-Linkage Fingerprint” means a cryptographic representation, computed inside a Trusted Execution Environment, of the degree of non-independence between two trading accounts, derived from a feature vector that may include hashed funding-source identifiers, hashed settlement-counterparty identifiers, internet-protocol geolocation prefixes, device-attestation identifiers, temporal-pattern vectors, and co-movement vectors.

“Attestation Quote” means a cryptographically signed statement produced by or on behalf of a Trusted Execution Environment binding together a measurement of the code base executing within the TEE, report data optionally specified by said code, and a hardware-vendor chain of trust verifiable by a relying party independently of the operator of the TEE.

“Cross-Exchange Attestation Aggregation” means the receipt by an attestation aggregator of Attestation Quotes from Trusted Execution Environments operated by multiple prediction-market exchanges and the production of cross-venue linkage findings inside the aggregator's own TEE, each cross-venue finding itself attested.

“Designated Contract Market” means an electronic trading venue regulated by the United States Commodity Futures Trading Commission under Section 5 of the Commodity Exchange Act, including without limitation venues offering prediction-market contracts under such designation.

“Divergence Record” means a cryptographically attested record produced inside an independent Trusted Execution Environment upon detection of any non-equivalence between regulator-computed classifications and classifications received in an exported audit record, binding together the received classifications, the regulator-computed classifications, the verified measurement of the surveillance code base, the verified input commitments, and a hardware-attestation quote produced by the independent TEE.

“Hardware Trusted Execution Environment” or “Hardware TEE” means a hardware-isolated execution context supported by a general-purpose processor or equivalent hardware, the integrity of whose contents is measurable by the hardware and attestable remotely through a cryptographic quote signed by a key rooted in the hardware. Non-limiting examples include Intel Software Guard Extensions, Intel Trust Domain Extensions, AMD Secure Encrypted Virtualization with Secure Nested Paging, ARM Confidential Compute Architecture, IBM Secure Execution for Linux, AWS Nitro Enclaves, Microsoft Azure Confidential Virtual Machines, Google Cloud Confidential Computing, and equivalent or successor technologies.

“Hardware-Vendor Attestation Service” means a verification service operated by or on behalf of a hardware vendor providing verification of Attestation Quotes against the vendor's root of trust, including Intel Provisioning Certification Service, AMD Versioned Chip Endorsement Key infrastructure, an ARM Confidential Compute Architecture verification service, an AWS Nitro attestation verification service, and equivalent vendor-operated services.

“Linkage Grouping” means a set of trading accounts identified by a Linkage-Analysis Module as having pairwise account-linkage scores collectively exceeding a configured linkage threshold, as detected by connected-component analysis, community-detection algorithms, density-based clustering, or equivalent methods.

“Measured Surveillance Code Base” means the surveillance code base loaded into a Trusted Execution Environment at instantiation and measured by the hardware, the measurement value being incorporated into subsequent Attestation Quotes issued by the TEE.

“Merkle Accumulator” means an append-only data structure whose elements are cryptographic digests of surveillance outputs and their associated Attestation Quotes, supporting computation of a root commitment over all appended elements and supporting inclusion proofs for each appended element relative to a previously committed root.

“Order-Flow Record” means a record describing a single order event submitted to or matched by a prediction-market exchange, including without limitation an order identifier, a submitting account identifier, an order type, a quantity, a limit price, a timestamp, a session identifier, and routing-source metadata.

“Prediction Market Contract” means an instrument traded on a Prediction Market Exchange whose payout is contingent on the occurrence or non-occurrence of a specified future event, including binary option contracts, event contracts, categorical outcome contracts, scalar outcome contracts, and combinations thereof.

“Prediction Market Exchange” means an electronic venue on which Prediction Market Contracts are offered, matched, and settled, including Designated Contract Markets under the Commodity Exchange Act, registered exchanges under applicable securities laws, equivalent regulated venues in foreign jurisdictions, and self-regulated venues operating pursuant to internal or industry rules.

“Publicly Verifiable Data Registry” means any of a public blockchain, a permissioned distributed ledger, a transparency log, a notarization registry, or any other data registry providing public-key-infrastructure-independent timestamping and tamper-evidence to a verifier without privileged access.

“Regulator Re-Execution” means the process by which a regulator instantiates an independent Trusted Execution Environment, loads the Measured Surveillance Code Base, verifies equality of the independent TEE's measurement to a measurement received in an exported audit record, supplies input records verified against sealed cryptographic commitments, re-executes the surveillance code base, and produces regulator-computed classifications for comparison with classifications received in the exported audit record.

“Regulator-Grade Evidence Bundle” means a self-contained, tamper-evident, attested bundle assembled from selected entries of the Tamper-Evident Audit Ledger and accompanying attestation evidence, configured to support review by a regulatory authority or independent auditor.

“Resolution Oracle TEE” means a Hardware Trusted Execution Environment configured to load a measured resolution-oracle code base, ingest designated input data sources over encrypted channels terminating within said TEE upon occurrence of a resolution event for a Prediction Market Contract, apply a deterministic resolution rule committed at contract listing, produce a Resolution Outcome, and produce an Attestation Quote cryptographically binding the Resolution Outcome to the resolution-oracle code measurement, the input commitments, and the deterministic resolution rule.

“Resolution Outcome” means the outcome of a Prediction Market Contract upon occurrence of a resolution event, produced inside a Resolution Oracle TEE by application of a deterministic resolution rule committed at contract listing to designated input data sources, and bound by an Attestation Quote to the resolution-oracle code measurement, the input commitments, and the resolution rule.

“Surveillance Module” means a software module executing within a Trusted Execution Environment configured to classify trade patterns among identified Linkage Groupings as wash-trading indicators, coordinated-trading indicators, or collusion indicators.

“Surveillance Parameter Commitment” means a cryptographic commitment, computed inside a Trusted Execution Environment and incorporated into an Attestation Quote, over the surveillance parameters in force during a covered interval, including without limitation a configured linkage threshold, configured time windows, configured net-position thresholds, configured mutual-information thresholds, classifier identifiers, classifier version numbers, and parameters of any grouping algorithm.

“Wash-Trading Indicator” means a classification produced by a Surveillance Module identifying a round-trip transaction sequence among accounts in a Linkage Grouping in which the net position change across the grouping, measured over a configured time window, is below a configured net-position threshold.

“Zero-Knowledge Proof” means a cryptographic proof, produced inside a Trusted Execution Environment, demonstrating that a stated computation was performed on inputs consistent with a committed input set, without disclosing the plaintext of the inputs or other sensitive intermediate values.

### System Overview

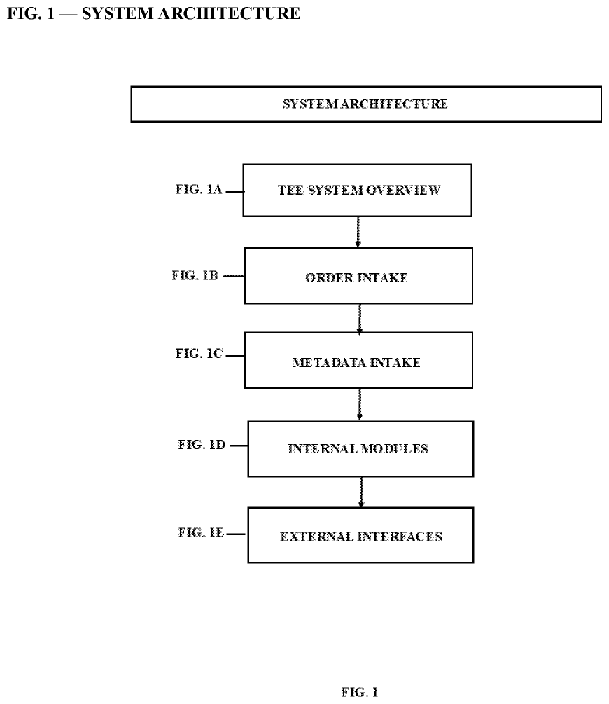

Referring to FIG. 1A, the platform comprises a hardware Trusted Execution Environment (110) instantiated on host hardware supporting at least one of Intel Software Guard Extensions, Intel Trust Domain Extensions, AMD Secure Encrypted Virtualization with Secure Nested Paging, ARM Confidential Compute Architecture, IBM Secure Execution for Linux, AWS Nitro Enclaves, Microsoft Azure Confidential Virtual Machines, Google Cloud Confidential Computing, or equivalent TEE technology. Order-Intake Interface (120), Account-Metadata Interface (125), Linkage-Analysis Module (130), Surveillance Module (140), Attestation Module (150), Tamper-Evident Audit Ledger (160), and Regulatory-Export Interface (170) cooperate to produce surveillance findings, audit records, and regulatory exports bound by hardware-attestation quotes verifiable independently of the exchange operator. Linkage-Analysis Module (130), Surveillance Module (140), and Attestation Module (150) execute entirely within Trusted Execution Environment (110). Order-Intake Interface (120) and Account-Metadata Interface (125) deliver inputs to the TEE over encrypted channels terminating within the TEE. Tamper-Evident Audit Ledger (160) and Regulatory-Export Interface (170) receive hardware-signed writes from the TEE. The system further interoperates with Resolution-Oracle TEE (200), Attestation Aggregator (300), and a regulator-operated independent TEE (400) supporting deterministic re-execution.

### Order and Metadata Ingestion

Referring to FIG. 1B, Order-Intake Interface (120) receives, from an exchange matching engine or equivalent order-routing system, a stream of Order-Flow Records. Each Order-Flow Record comprises an order identifier, a submitting account identifier, an order type (including without limitation limit, market, immediate-or-cancel, fill-or-kill, and post-only), a quantity, a limit price, a timestamp from a TEE-attested time source, a session identifier, and routing-source metadata where available. Order-Flow Records are delivered over a transport-layer-secure channel whose server-side endpoint terminates within Trusted Execution Environment (110). Plaintext of Order-Flow Records does not traverse any channel outside the TEE.

Referring to FIG. 1C, Account-Metadata Interface (125) receives account-level metadata over encrypted channels terminating within Trusted Execution Environment (110). Account-level metadata may comprise funding-source identifiers; settlement-counterparty identifiers; know-your-customer attestations received in cryptographically signed form from regulated counterparties including futures commission merchants, broker-dealers, and banks; anti-money-laundering screening results; sanctions-screening results; device-attestation records from end-user devices where available; and internet-protocol-level attributes of observed session traffic. Account-level metadata is processed in hashed or otherwise privacy-preserving form where required by applicable privacy law, and plaintext of personally identifying information does not traverse any channel outside the TEE.

Encryption keys for the transport channels into Trusted Execution Environment (110) are derived inside the TEE from hardware-rooted key material and are bound to the measurement of the surveillance code base. A counterparty submitting records over the channel verifies the TEE's identity by exchanging an attestation quote at session establishment; the channel is established only if the counterparty's verification of the attestation quote succeeds against the corresponding Hardware-Vendor Attestation Service.

### Account Linkage Analysis

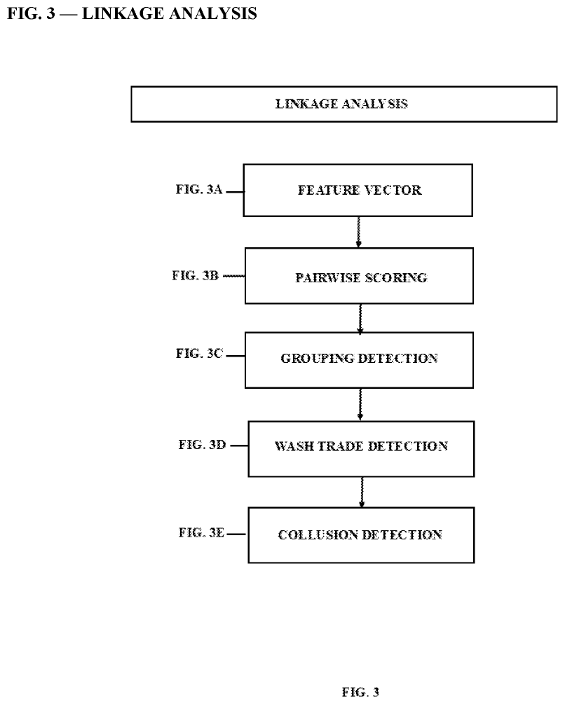

Referring to FIG. 3A, Linkage-Analysis Module (130) executes within Trusted Execution Environment (110). For each pair of accounts observed trading in a given interval, Linkage-Analysis Module (130) computes an Account-Linkage Fingerprint representing the pair's degree of non-independence. The fingerprint is computed from a feature vector that may include hashed funding-source institution identifiers; hashed settlement-counterparty identifiers; internet-protocol geolocation prefixes of observed session endpoints; device-attestation identifiers; temporal-pattern vectors representing order-submission distributions; co-movement vectors representing joint response to common market events; and graph-theoretic features representing position within a global linkage graph maintained within the TEE.

Referring to FIG. 3B, Linkage-Analysis Module (130) computes pairwise linkage scores from the feature vectors. In one embodiment, linkage scores are computed as weighted Jaccard similarities on hashed categorical features combined with mutual-information estimates on temporal and behavioral features. In another embodiment, linkage scores are produced by a supervised classifier trained on labeled historical linkage data and executed entirely within Trusted Execution Environment (110). In a further embodiment, linkage scores are produced by unsupervised clustering of the feature vectors followed by conversion of cluster membership to pairwise scores. The invention is not limited to any particular score-computation methodology.

Referring to FIG. 3C, Linkage-Analysis Module (130) identifies Linkage Groupings of accounts whose pairwise linkage scores, taken collectively, exceed a configured linkage threshold. In one embodiment, groupings are identified as connected components of a graph whose vertices are accounts and whose edges are pairs with linkage scores above the configured threshold. In another embodiment, groupings are identified by community-detection algorithms such as Louvain modularity optimization. In a further embodiment, groupings are identified by density-based clustering in the linkage-score space. The configured linkage threshold and the parameters of any grouping algorithm are themselves committed to as part of the Surveillance Parameter Commitment produced by Attestation Module (150).

Linkage-Analysis Module (130) maintains a global linkage graph entirely within Trusted Execution Environment (110), updating the graph upon ingestion of each Order-Flow Record and each Account-Metadata Record. The graph is not exposed in plaintext outside the TEE. Snapshots of the graph at configured intervals are committed to Tamper-Evident Audit Ledger (160) by hash only; the plaintext graph remains sealed inside the TEE and is recoverable only through Regulator Re-Execution.

### Trade Pattern Classification

Referring to FIG. 3D, Surveillance Module (140) classifies trade patterns among identified Linkage Groupings. For wash-trading classification, Surveillance Module (140) examines each grouping for round-trip transaction sequences in which offsetting positions are opened and closed among accounts in the grouping such that the net position change across the grouping, measured over a configured time window, is below a configured net-position threshold. The configured time window and the configured net-position threshold are themselves parameters of the Surveillance Parameter Commitment. Wash-trading classifications are produced at per-grouping and per-sequence granularity and are accompanied by supporting evidence in hashed form.

In further embodiments, Surveillance Module (140) detects wash-trading patterns involving non-trivial economic motion, including round trips accompanied by fee capture, rebate capture, or other non-position-change economic consequences; detects wash-trading patterns masquerading as market-making activity by examining the diversity of counterparties observed outside the linkage grouping; and incorporates market-context features including time-of-day, contract liquidity regime, and concurrent market events into the classification decision.

Referring to FIG. 3E, Surveillance Module (140) classifies coordinated-trading and collusion indicators. In one embodiment, Surveillance Module (140) computes temporal-correlation statistics among orders submitted by accounts in a grouping and flags groupings exhibiting mutual-information or cross-correlation exceeding configured thresholds. In another embodiment, Surveillance Module (140) detects coordinated response patterns in which accounts in a grouping systematically enter or exit positions within a configured response window of a specified trigger event, such as a news release, an oracle update, or an executed order on the same or related contracts.

In a further embodiment specific to Prediction Market Contracts, Surveillance Module (140) identifies coordinated resolution-direction patterns in which accounts in a Linkage Grouping accumulate position in the eventually-correct resolution outcome at a rate statistically improbable absent non-public information. Surveillance Module (140) distinguishes forecasting skill from informational collusion by reference to account-level historical-accuracy profiles computed within Trusted Execution Environment (110). Surveillance Module (140) further applies a configured risk-weighting to detected patterns based on at least one of trader capital at risk, account age, and historical prior-violation status.

### Attestation Quote Generation

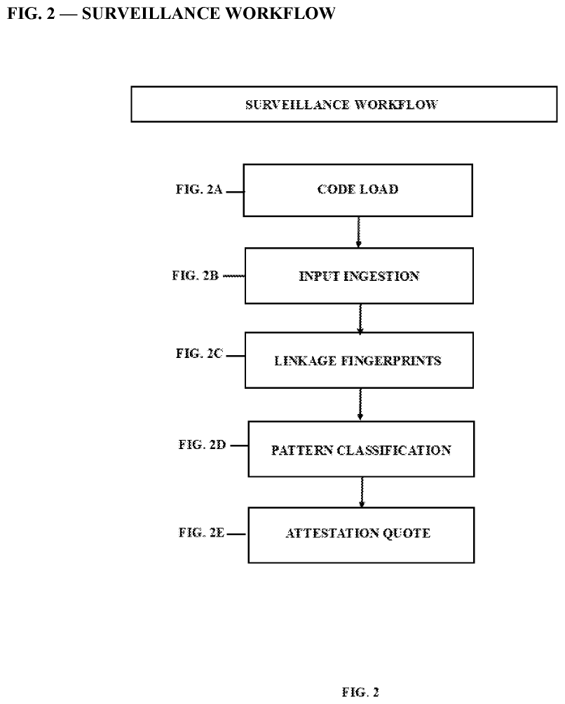

Referring to FIG. 2E, Attestation Module (150) executes within Trusted Execution Environment (110) and produces hardware-attestation quotes on a configured schedule and, optionally, on an event-driven basis following production of each high-severity surveillance classification. Each attestation quote (152) binds together (i) the measurement value of the surveillance code base as measured by hardware; (ii) a cryptographic commitment over the set of Order-Flow Records and Account-Metadata Records ingested during the covered interval, in one embodiment a Merkle root over per-record hashes; (iii) a Surveillance Parameter Commitment over the surveillance parameters in force during the interval, including linkage thresholds, time windows, classifier identifiers, and grouping-algorithm parameters; and (iv) a cryptographic commitment over the surveillance classifications produced during the interval.

Each attestation quote (152) recorded in Tamper-Evident Audit Ledger (160) conforms to a canonical, versioned schema. The schema comprises at least the following fields: quote_identifier; tee_measurement; tee_attestation_quote_format; hardware_vendor_root_of_trust_reference; input_records_commitment; surveillance_parameter_commitment; classification_commitment; covered_interval_start_timestamp; covered_interval_end_timestamp; hardware_vendor_signature; report_data_field_contents; tee_platform_identifier; tee_security_version_number; classification_severity_summary; grouping_identifier_list; merkle_inclusion_path; prior_quote_hash; publicly_verifiable_data_registry_anchor_reference; report_data_hash_algorithm_identifier; and regulatory_export_format_identifier.

Attestation quotes are produced in formats verifiable against the corresponding Hardware-Vendor Attestation Service. In embodiments using Intel SGX or Intel TDX, quotes are produced in accordance with Intel Data Center Attestation Primitives formats and are verifiable against Intel Provisioning Certification Service. In embodiments using AMD SEV-SNP, attestation reports are produced and verifiable against AMD's Versioned Chip Endorsement Key infrastructure. In embodiments using ARM Confidential Compute Architecture, attestation tokens are produced in accordance with applicable standards. In embodiments using AWS Nitro Enclaves, attestation documents are produced and verifiable against the AWS Nitro attestation verification service. The invention is not limited to any particular attestation format and may be practiced with any format providing cryptographic binding of code measurement to report data and verifiable through an independent hardware-vendor trust root.

Each attestation quote is exported to Tamper-Evident Audit Ledger (160) over a hardware-signed write. As used herein, a “hardware-signed write” comprises any one of: (i) a write signed using a TEE attestation key rooted in the hardware vendor's trust infrastructure; (ii) a write signed using an enclave-held application signing key sealed to the TEE measurement; (iii) a write signed using a vendor-rooted attestation mechanism in which the TEE-produced signature is verifiable against a Hardware-Vendor Attestation Service; or (iv) a write signed using a derived key whose use is conditioned on production of a valid attestation quote. A Regulator-Grade Evidence Bundle is produced on demand by an Evidence Bundle Generator (155) executing within Trusted Execution Environment (110). The Regulator-Grade Evidence Bundle conforms to a canonical schema comprising selected entries from Tamper-Evident Audit Ledger (160); a lineage of attestation quotes covering the surveillance interval at issue; the corresponding TEE measurements and hardware-vendor verification artifacts; the input-records commitment and any selectively disclosed input records together with their Merkle inclusion proofs; the Surveillance Parameter Commitment and the parameter values in plaintext; the classifications produced during the interval, optionally accompanied by Zero-Knowledge Proofs (180) of integrity; cross-references to any related Resolution Outcomes; the rollback or correction history, if any; and a signed bundle manifest bearing an attestation quote produced by an authorized TEE.

### Tamper-Evident Audit Ledger

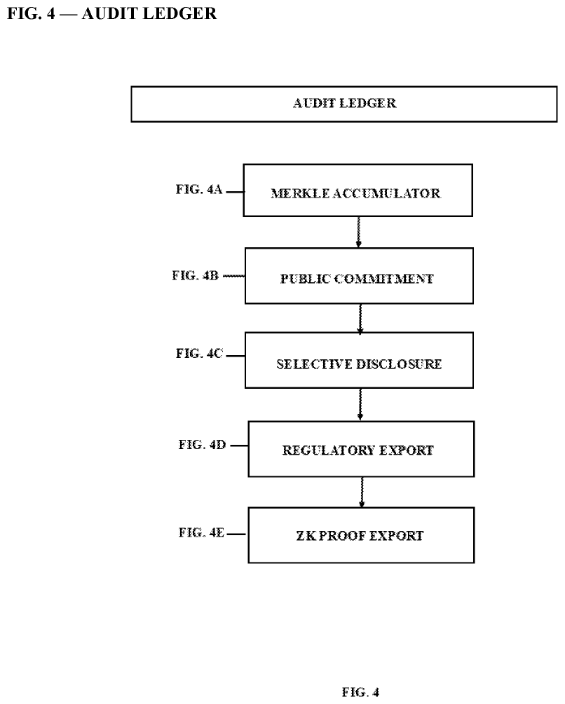

Referring to FIG. 4A, Tamper-Evident Audit Ledger (160) is maintained external to Trusted Execution Environment (110) but receives only hardware-signed writes therefrom. In one embodiment, Tamper-Evident Audit Ledger (160) is implemented as a Merkle accumulator whose Merkle Root (162) is periodically committed to Publicly Verifiable Data Registry (164). Publicly Verifiable Data Registry (164) is selected from a public blockchain, a permissioned distributed ledger, a transparency log, a notarization registry, or any equivalent tamper-evident registry. Public commitment of Merkle Root (162) ensures that historical surveillance outputs cannot be rewritten without detection by any single party, including the exchange operator.

Each entry in Tamper-Evident Audit Ledger (160) conforms to a canonical, versioned ledger-entry schema comprising at least the following fields: ledger_entry_id; prior_entry_hash; quote_identifier; tee_measurement; input_records_commitment; surveillance_parameter_commitment; classification_commitment; classification_severity_summary; covered_interval_start_timestamp; covered_interval_end_timestamp; hardware_vendor_root_of_trust_reference; hardware_vendor_signature; merkle_inclusion_path; prior_quote_hash; publicly_verifiable_data_registry_anchor_reference; and regulatory_export_format_identifier. Each ledger entry is linked to a prior ledger entry through the prior_entry_hash field, which contains a cryptographic digest of the immediately preceding ledger entry, and is incorporated into the Merkle accumulator such that the current Merkle root commits to the current entry and to all prior entries. Periodic commitment of the Merkle root to the Publicly Verifiable Data Registry anchors the ledger state at known external timestamps.

Referring to FIG. 4C, Tamper-Evident Audit Ledger (160) supports selective disclosure. A disclosure request specifying an account identifier, a time range, or a contract identifier is served by producing the relevant surveillance outputs, the corresponding attestation quotes, and Merkle inclusion proofs demonstrating that the produced outputs are elements of the accumulator whose roots were previously committed to Publicly Verifiable Data Registry (164). Regulators may thereby verify completeness of disclosed records, subject to the rate at which Merkle roots are publicly committed. Referring to FIG. 4D, Regulatory-Export Interface (170) produces outputs in formats configured to support submission to regulator-designated reporting systems, including outputs configured to support submission compliant with 17 C.F.R. Part 16, 17 C.F.R. Part 17, and 17 C.F.R. Part 45 for Designated Contract Markets; outputs configured to support submission to the Consolidated Audit Trail under SEC Rule 613 of Regulation NMS for venues subject to securities-law designation; and custom export formats specified by foreign regulators. Referring to FIG. 4E, Zero-Knowledge Proofs (180) are exported alongside selected disclosures, demonstrating that surveillance classifications were computed on inputs consistent with the committed input set without disclosing the plaintext of the input records.

### Hardware-Attested Resolution

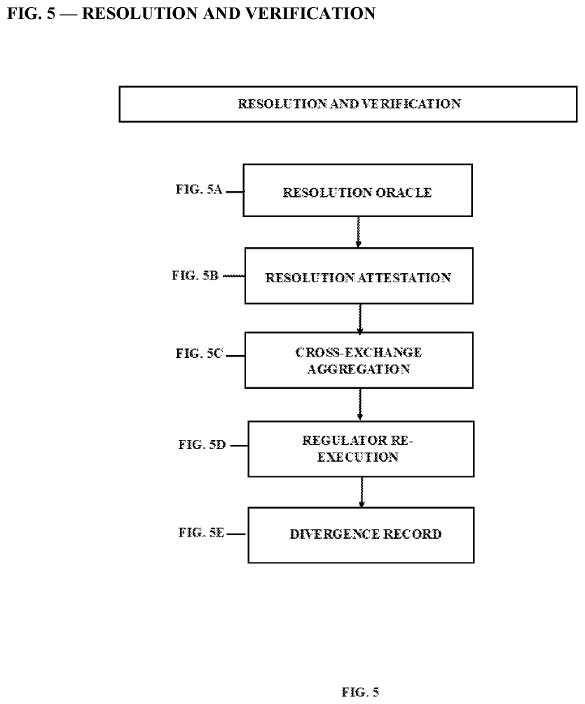

Referring to FIG. 5A, upon occurrence of a resolution event for a Prediction Market Contract, Resolution-Oracle TEE (200) ingests designated input data sources over encrypted channels terminating within Resolution-Oracle TEE (200). The designated input data sources may comprise cryptographically signed feeds from governmental bodies; cryptographically signed feeds from regulated data vendors; on-chain sources whose authenticity is verifiable through cryptographic signatures; multi-source consensus protocols operating over a defined quorum of sources; and combinations of the foregoing. A resolution-rule module executing within Resolution-Oracle TEE (200) applies a deterministic resolution rule, specified in the contract terms and committed to by hash at contract listing on a Publicly Verifiable Data Registry, to the ingested inputs and produces a Resolution Outcome.

Referring to FIG. 5B, an attestation module executing within Resolution-Oracle TEE (200) produces a hardware-attestation quote binding together (i) a measurement of the resolution-oracle code base; (ii) cryptographic commitments to the ingested input data sources; (iii) the deterministic resolution rule, or a hash thereof committed at contract listing; and (iv) the Resolution Outcome. The attested Resolution Outcome is delivered to the exchange's settlement system as the final resolution of the contract, without dependence on a software-based optimistic-oracle dispute channel. Because the resolution code, the inputs, and the rule are cryptographically committed and hardware-attested, the resolution is independently verifiable by any party, including dissatisfied counterparties, without reintroducing an optimistic-dispute channel that could compromise settlement finality. In a further embodiment, a Merkle accumulator maintained within or under control of Resolution-Oracle TEE (200) appends digests of Resolution Outcomes and their hardware-attestation quotes, a root of said Merkle accumulator being periodically committed to a Publicly Verifiable Data Registry, and the cryptographic commitments to the input data sources may be selectively disclosed under inclusion proofs to enable independent re-execution of the resolution.

### Regulator Re-Execution

Referring to FIG. 5D, a regulator receiving an exported audit record from the prediction market exchange instantiates an independent Trusted Execution Environment (400) on infrastructure operated by or on behalf of the regulator. The regulator verifies the hardware-attestation quote contained in the exported audit record against the Hardware-Vendor Attestation Service. The regulator loads the Measured Surveillance Code Base into independent TEE (400) and verifies that the independent TEE's measurement of the loaded code base equals the hardware-rooted measurement received in the exported audit record. The regulator supplies, to independent TEE (400), input records verified against the sealed cryptographic commitments in the exported audit record. Independent TEE (400) re-executes the surveillance code base on the supplied input records and produces regulator-computed classifications. The regulator verifies bit-identical equivalence between the regulator-computed classifications and the classifications received in the exported audit record. Bit-identical equivalence is satisfied when each regulator-computed classification is byte-for-byte equal to the corresponding received classification under the canonical serialization specified by the surveillance code base.

Referring to FIG. 5E, upon detection of any divergence between the regulator-computed classifications and the classifications received in the exported audit record, independent TEE (400) produces a Divergence Record (410) cryptographically binding together (i) the received classifications; (ii) the regulator-computed classifications; (iii) the verified measurement of the surveillance code base; (iv) the verified input commitments; and (v) a hardware-attestation quote produced by independent TEE (400). The Divergence Record is committed to a tamper-evident audit ledger or a regulator-controlled registry. The Divergence Record indicates at least one of computational error, non-deterministic execution, inconsistent input reconstruction, or operator interference. Referring further to FIG. 5C, an Attestation Aggregator (300) operating in its own Trusted Execution Environment receives attestation quotes from Trusted Execution Environments operated by multiple prediction-market exchanges and performs cross-exchange linkage analysis identifying accounts trading across exchanges under different counterparty identifiers but exhibiting non-independence; cross-exchange linkage findings are themselves attested by Attestation Aggregator (300).

DETERMINISTIC EXECUTION CONTROLS. To support bit-identical Regulator Re-Execution, the platform enforces the following deterministic execution controls inside Trusted Execution Environment (110) and Resolution-Oracle TEE (200): a fixed code-base measurement reproducible across compatible TEE platforms of the same vendor and security version; versioned surveillance parameters identified in the Surveillance Parameter Commitment by version number and content hash; fixed random seeds for any pseudo-random operation, derived from inputs to the relevant computation rather than from system entropy; deterministic data ordering by canonical sort over a stable key prior to any aggregation or graph operation; canonical serialization of input records and intermediate values using a versioned canonical encoding; versioned classifier identifiers identifying each classifier by model hash and version; a hardware-attested time source for all timestamps used in surveillance and resolution computations; a reproducible computation path such that the same code base executing on the same canonical inputs with the same parameters produces byte-identical outputs; and bit-identical re-execution criteria requiring byte-for-byte equivalence between regulator-computed outputs and outputs received in the exported audit record under the canonical serialization specified by the surveillance code base.

### Enablement Example 1—Event Contract Surveillance

A Designated Contract Market regulated by the Commodity Futures Trading Commission lists an event contract on the resolution of a publicly observable political event approximately ninety days forward. The exchange operates Trusted Execution Environment (110) on Intel TDX. The exchange loads the Measured Surveillance Code Base into the TDX trust domain (110), and the measurement is published to a Publicly Verifiable Data Registry at code-base release time. Order flow on the event contract is delivered into the TDX trust domain (110) over a transport-layer-secure channel terminating inside the TEE. KYC and AML attestations are received from intermediating futures commission merchants in cryptographically signed form and ingested through Account-Metadata Interface (125).

Twelve days before resolution, Linkage-Analysis Module (130) detects a grouping of seventeen accounts whose pairwise linkage scores collectively exceed the configured linkage threshold on the basis of shared hashed funding-source institutions, overlapping internet-protocol geolocation prefixes, and a co-movement vector indicating coordinated entry into a directional position. Surveillance Module (140) computes mutual-information statistics among the grouped accounts' order timing, the statistics exceeding the configured collusion threshold, and classifies the pattern as a collusion indicator. Attestation Module (150) produces a hardware-attestation quote (152) binding together the surveillance code-base measurement, the Merkle root over the day's order-flow and metadata records, the Surveillance Parameter Commitment, and the classification. Tamper-Evident Audit Ledger (160) appends the classification and the quote, and Merkle Root (162) is committed to a permissioned distributed ledger anchoring service. Regulatory-Export Interface (170) generates a reporting record configured to support submission under 17 C.F.R. Part 17 covering the grouping. The chief compliance officer receives a real-time alert accompanied by the attestation quote and forwards the export to the Division of Market Oversight of the Commodity Futures Trading Commission. The Division of Market Oversight instantiates independent TEE (400) on Commission-operated infrastructure, loads the Measured Surveillance Code Base, supplies the sealed input commitments from the exported audit record, re-executes the surveillance operations, and verifies bit-identical reproduction of the exchange's collusion classification, thereby providing independent regulator confirmation.

### Enablement Example 2—Binary Option Resolution

A Prediction Market Exchange offers a binary option contract that pays $1.00 per contract upon occurrence of a specified observable event prior to a specified expiration time, and $0.00 otherwise. The contract terms specify a deterministic resolution rule committing to the following order of precedence among designated input sources: (i) a cryptographically signed feed from a designated governmental body; (ii) a cryptographically signed feed from a designated regulated data vendor; and (iii) a two-of-three multi-source consensus among three configured on-chain oracle feeds. The deterministic resolution rule provides that the outcome is determined by source (i) if its signed response is received within a configured response window; otherwise by source (ii) if its signed response is received within the response window; otherwise by source (iii) if at least two of the three on-chain oracle feeds agree. A hash of the deterministic resolution rule is committed at contract listing to a Publicly Verifiable Data Registry.

Upon occurrence of the resolution event, Resolution-Oracle TEE (200), executing on AWS Nitro Enclaves, ingests the three designated input sources over encrypted channels terminating within Resolution-Oracle TEE (200). The governmental feed and the regulated data vendor feed each return a signed response affirming occurrence of the event; the two-of-three on-chain oracle consensus confirms the same result. The resolution-rule module applies the deterministic rule and produces a Resolution Outcome of “YES.” An attestation module executing within Resolution-Oracle TEE (200) produces an attestation quote whose fields bind the Resolution Outcome to (i) the resolution-oracle code measurement; (ii) the cryptographic commitments to the three input sources; (iii) the hash of the deterministic resolution rule committed at contract listing; and (iv) the Resolution Outcome itself. The attested Resolution Outcome is delivered to the exchange's settlement system. Settlement occurs without dependence on a software-based optimistic-oracle dispute window. A dissatisfied counterparty subsequently requests independent verification, instantiates a Trusted Execution Environment on its own infrastructure, loads the certified resolution-oracle code base, supplies the input commitments and signed feeds, and re-executes the resolution. The re-execution produces a bit-identical “YES” outcome, confirming the exchange's settlement without reintroducing a dispute channel. Where a re-executed outcome would differ from the attested outcome, the counterparty's TEE produces a Divergence Record cryptographically binding the attested outcome, the re-executed outcome, the verified resolution-oracle code measurement, the verified input commitments, and a hardware-attestation quote from the counterparty's TEE, and the Divergence Record is committed to a regulator-controlled registry, indicating at least one of computational error, non-deterministic execution, inconsistent input reconstruction, or operator interference.

### Technical Problem and Solution

Prediction-market surveillance and contract resolution are routinely performed in software-only environments without hardware-rooted proof that surveillance findings or resolution outcomes are the product of certified code operating on certified inputs. Conventional software-only audit databases are modifiable by their operator. Conventional optimistic-oracle architectures depend on dispute economics and undermine settlement finality. Regulators cannot today obtain independent cryptographic confirmation that a regulated party's surveillance findings are exactly those produced by the certified code on the certified inputs. The disclosed platform addresses these problems by combining, in a single integrated system, hardware-rooted execution of surveillance and resolution-oracle logic; encrypted ingestion of order flow, account metadata, and resolution inputs over channels terminating inside the TEE; a Measured Surveillance Code Base whose measurement is incorporated into each Attestation Quote; deterministic computation enforced by canonical serialization, fixed seeds, versioned parameters, and a hardware-attested time source; hardware-attestation quotes binding code measurement, input commitment, parameter commitment, and output; a tamper-evident Merkle-accumulator audit ledger whose roots are anchored to a Publicly Verifiable Data Registry; and independent Regulator Re-Execution producing bit-identical confirmation or a cryptographically attested Divergence Record. The combination improves the functioning of the computer system itself by transforming surveillance and resolution from operator-trusted software outputs into cryptographically gated, hardware-attested, independently re-executable computations, addressing a systemic trust failure in regulated trading infrastructure.

### Advantages of the Invention

The platform provides multiple technical and operational benefits. Hardware-rooted execution reduces the risk of operator tampering with surveillance findings and resolution outcomes. Hardware-attested gating reduces the manual compliance review required to confirm that findings were produced by certified code. Cryptographic evidence of code measurement, input commitments, and outputs supports faster regulatory audits. Tamper-evident Merkle-accumulator ledgers anchored to a Publicly Verifiable Data Registry provide stronger surveillance integrity over time. Hardware-attested resolution outcomes provide settlement finality without dependence on an optimistic-oracle dispute window, eliminating the optimistic-oracle finality risk. Selective disclosure with Merkle inclusion proofs and Zero-Knowledge Proofs provides privacy-preserving disclosure of specified records without exposing the underlying record set. Cross-Exchange Attestation Aggregation enables jurisdiction-wide linkage detection across multiple venues without any single operator holding privileged access. Independent Regulator Re-Execution provides cryptographic confirmation of surveillance findings without reliance on operator representations. Tamper-evident audit history permits longitudinal verification across reporting periods. The platform reduces reliance on operator representations and scales to institutional order surveillance.

### ALTERNATIVES AND SCOPE

Components disclosed herein may be combined, distributed, omitted, or supplemented without departing from the scope of the disclosure. Alternative Trusted Execution Environment technologies, alternative attestation-quote formats, alternative cryptographic graph-analysis methodologies, alternative Merkle-accumulator constructions, alternative Publicly Verifiable Data Registries, alternative zero-knowledge proof systems, and alternative regulatory frameworks are expressly contemplated. The disclosure extends beyond Prediction Market Exchanges to any electronic trading venue subject to surveillance, audit, and regulatory-reporting obligations, including traditional derivatives exchanges, securities exchanges, alternative trading systems, crypto exchanges, decentralized finance protocols operating under regulated frameworks, and foreign regulated venues. The disclosure further extends to surveillance of non-trading activities subject to regulator-verifiable evidence requirements, including financial-crime monitoring, economic-sanctions screening, and cross-border-transfer surveillance, where the disclosed architecture may be adapted to the corresponding input and output domains. Each module disclosed herein may be embodied independently, in sub-combination, or in combination.

The terms “engine,” “module,” “layer,” “attestor,” “prover,” “authority,” “controller,” “interface,” “aggregator,” “generator,” and “ledger” as used herein are not intended to invoke 35 U.S.C. § 112(f). Each such term denotes a class of computational structure described herein with sufficient specificity—including the algorithms, data structures, attested measurements, and cryptographic signatures recited in the corresponding sections of the Detailed Description—to identify the corresponding structure to a person of ordinary skill in the art.

What is claimed is:

1. A hardware-attested trade integrity system for a prediction market exchange, comprising:
(a) one or more hardware trusted execution environments (TEEs), each TEE configured to load a measured surveillance code base and to produce a hardware-rooted measurement of the measured surveillance code base verifiable against a hardware-vendor attestation service;
(b) an order-intake interface configured to deliver order-flow records associated with trading activity on the prediction market exchange into a first TEE of the one or more TEEs over a first encrypted channel terminating within the first TEE;
(c) an account-metadata interface configured to deliver account-metadata records associated with the trading activity into the first TEE over a second encrypted channel terminating within the first TEE;
(d) a linkage-analysis module executing within the first TEE and configured to compute, from features of the order-flow records and the account-metadata records, cryptographic account-linkage fingerprints, and to identify, from the cryptographic account-linkage fingerprints, one or more linkage groupings of accounts whose pairwise linkage scores exceed a configured linkage threshold;
(e) a surveillance module executing within the first TEE and configured to classify, based at least in part on the one or more linkage groupings, trade patterns as one or more of wash-trading indicators, coordinated-trading indicators, and collusion indicators, the surveillance module producing one or more classifications during a covered interval;
(f) an attestation module executing within the first TEE and configured to produce a hardware-attestation quote cryptographically binding together (i) the hardware-rooted measurement of the measured surveillance code base, (ii) a cryptographic commitment over the order-flow records and the account-metadata records ingested during the covered interval, (iii) a surveillance parameter commitment over surveillance parameters in force during the covered interval, the surveillance parameters including at least the configured linkage threshold, and (iv) the one or more classifications produced during the covered interval;
(g) a tamper-evident audit ledger configured to receive hardware-signed writes from the first TEE and to record the one or more classifications and the hardware-attestation quote in an append-only data structure, a root of the append-only data structure being periodically committed to a publicly verifiable data registry selected from a public blockchain, a permissioned distributed ledger, a transparency log, a notarization registry, and any combination of the foregoing;
(h) wherein the system is configured such that no classification of the one or more classifications is admissible as a regulator-verifiable record unless (i) the classification was produced by the measured surveillance code base executing within an authorized one of the one or more TEEs on records ingested over an encrypted channel terminating within the authorized TEE, and (ii) the classification is cryptographically bound in the hardware-attestation quote that ties together the hardware-rooted measurement, the cryptographic commitment over the order-flow records and the account-metadata records, the surveillance parameter commitment, and the classification, the hardware-attestation quote being independently verifiable against the hardware-vendor attestation service.

2. A computer-implemented method of producing a regulator-verifiable trade integrity record for a prediction market exchange, the method comprising:
(a) loading a measured surveillance code base into a hardware trusted execution environment (TEE), the TEE producing a hardware-rooted measurement of the measured surveillance code base verifiable against a hardware-vendor attestation service;
(b) ingesting, into the TEE over an encrypted channel terminating within the TEE, order-flow records and account-metadata records associated with trading activity on the prediction market exchange;
(c) computing, within the TEE, cryptographic account-linkage fingerprints from features of the ingested records, identifying one or more linkage groupings of accounts whose pairwise linkage scores exceed a configured linkage threshold, and classifying trade patterns among the identified one or more linkage groupings as one or more of wash-trading indicators, coordinated-trading indicators, and collusion indicators, to produce one or more classifications;
(d) producing, within the TEE, a hardware-attestation quote cryptographically binding the one or more classifications to the hardware-rooted measurement of the measured surveillance code base, to a cryptographic commitment over the ingested records, and to a surveillance parameter commitment over surveillance parameters in force during a covered interval, the surveillance parameters including at least the configured linkage threshold;
(e) rejecting any classification of the one or more classifications that does not satisfy both (i) production by the measured surveillance code base executing within the TEE on records ingested over the encrypted channel and (ii) cryptographic binding in the hardware-attestation quote verifiable against the hardware-vendor attestation service, and recording a signed rejection record in a tamper-evident audit ledger; and
(f) for each classification of the one or more classifications not rejected, committing the classification and the hardware-attestation quote to the tamper-evident audit ledger as a new entry, a root of the tamper-evident audit ledger being periodically committed to a publicly verifiable data registry.

3. A non-transitory computer-readable medium storing program instructions that, when executed within a hardware trusted execution environment (TEE) of a computer system, cause the TEE to:
(a) receive, over an encrypted channel terminating within the TEE, order-flow records and account-metadata records associated with trading activity on a prediction market exchange;
(b) compute cryptographic account-linkage fingerprints from features of the received records, identify one or more linkage groupings of accounts whose pairwise linkage scores exceed a configured linkage threshold, and classify trade patterns as one or more of wash-trading indicators, coordinated-trading indicators, and collusion indicators, to produce one or more classifications;
(c) produce a hardware-attestation quote cryptographically binding the one or more classifications to a hardware-rooted measurement of the program instructions, to a cryptographic commitment over the received records, and to a surveillance parameter commitment over surveillance parameters in force during a covered interval, the surveillance parameters including at least the configured linkage threshold;
(d) reject any classification of the one or more classifications that does not satisfy both (i) production by the program instructions, measured to the hardware-rooted measurement, on records received over the encrypted channel and (ii) cryptographic binding in the hardware-attestation quote; and
(e) cause export of each classification of the one or more classifications not rejected and the corresponding hardware-attestation quote to a tamper-evident audit ledger whose root is periodically committed to a publicly verifiable data registry, in a form independently verifiable by a regulator against a hardware-vendor attestation service.

4. The system of claim 1, wherein each hardware-attestation quote recorded in the tamper-evident audit ledger conforms to a canonical, versioned attestation quote schema comprising at least the following fields: quote_identifier; tee_measurement; tee_attestation_quote_format; hardware_vendor_root_of_trust_reference; input_records_commitment; surveillance_parameter_commitment; classification_commitment; covered_interval_start_timestamp; covered_interval_end_timestamp; hardware_vendor_signature; report_data_field_contents; tee_platform_identifier; tee_security_version_number; classification_severity_summary; grouping_identifier_list; merkle_inclusion_path; prior_quote_hash; publicly_verifiable_data_registry_anchor_reference; report_data_hash_algorithm_identifier; and regulatory_export_format_identifier.

5. The system of claim 1, further comprising an evidence bundle generator executing within one of the one or more TEEs and configured to produce, on demand or upon a defined trigger event, a regulator-grade evidence bundle comprising at least: a set of selected entries from the tamper-evident audit ledger; a lineage of hardware-attestation quotes covering a specified surveillance interval; the hardware-rooted measurement and a hardware-vendor verification artifact for each hardware-attestation quote in the lineage; the cryptographic commitment over the order-flow records and the account-metadata records and any selectively disclosed records together with Merkle inclusion proofs therefor; the surveillance parameter commitment and corresponding parameter values; one or more classifications produced during the specified surveillance interval and, optionally, one or more zero-knowledge proofs of integrity therefor; a cross-reference to any related resolution outcome; a correction history, if any; and a signed bundle manifest bearing an attestation quote produced by an authorized TEE.

6. The system of claim 1, wherein the one or more TEEs comprise at least one of Intel Software Guard Extensions, Intel Trust Domain Extensions, AMD Secure Encrypted Virtualization with Secure Nested Paging, ARM Confidential Compute Architecture, IBM Secure Execution for Linux, AWS Nitro Enclaves, Microsoft Azure Confidential Virtual Machines, and Google Cloud Confidential Computing.

7. The system of claim 1, wherein the hardware-attestation quote is formatted in accordance with one of Intel Data Center Attestation Primitives, an AMD SEV-SNP attestation report format, an ARM Confidential Compute Architecture attestation token format, and an AWS Nitro Enclaves attestation document format, and wherein the hardware-vendor attestation service comprises one of Intel Provisioning Certification Service, AMD Versioned Chip Endorsement Key attestation infrastructure, an ARM Confidential Compute Architecture verification service, and an AWS Nitro attestation verification service.

8. The system of claim 1, wherein the linkage-analysis module is configured to compute each cryptographic account-linkage fingerprint from a feature vector comprising at least one of: a hashed funding-source identifier; a hashed settlement-counterparty identifier; an internet-protocol geolocation prefix of an observed session endpoint; a device-attestation identifier; a temporal-pattern vector representing an order-submission distribution; a co-movement vector representing joint response to a common market event; and a graph-theoretic feature representing position within a global linkage graph maintained within the first TEE.

9. The system of claim 1, wherein the surveillance module is configured to classify a trade pattern as a wash-trading indicator upon identification, within a linkage grouping of the one or more linkage groupings, of a round-trip transaction sequence in which a net position change across the linkage grouping, measured over a configured time window, is below a configured net-position threshold, and wherein the configured time window and the configured net-position threshold are included in the surveillance parameter commitment.

10. The system of claim 1, wherein the surveillance module is configured to classify a trade pattern as a collusion indicator upon identification, within a linkage grouping of the one or more linkage groupings, of (i) temporally-correlated order-submission patterns exceeding a configured mutual-information threshold or (ii) coordinated response patterns in which accounts in the linkage grouping systematically enter or exit positions within a configured response window of a specified trigger event.

11. The system of claim 1, wherein the tamper-evident audit ledger comprises a Merkle accumulator configured to append cryptographic digests of the one or more classifications and the hardware-attestation quote, a root of the Merkle accumulator being periodically committed to the publicly verifiable data registry, wherein each ledger entry of the tamper-evident audit ledger comprises at least the following fields: ledger_entry_id; prior_entry_hash; quote_identifier; tee_measurement; input_records_commitment; surveillance_parameter_commitment; classification_commitment; classification_severity_summary; covered_interval_start_timestamp; covered_interval_end_timestamp; hardware_vendor_root_of_trust_reference; hardware_vendor_signature; merkle_inclusion_path; prior_quote_hash; publicly_verifiable_data_registry_anchor_reference; and regulatory_export_format_identifier, and wherein the tamper-evident audit ledger is configured to support selective disclosure of one or more ledger entries together with Merkle inclusion proofs relative to previously committed roots.

12. The system of claim 1, further comprising a hardware-attested resolution-outcome subsystem comprising:
(a) a resolution-oracle TEE configured to load a measured resolution-oracle code base;
(b) a resolution-input interface configured to deliver, upon occurrence of a resolution event for a prediction market contract, designated input data sources into the resolution-oracle TEE over an encrypted channel terminating within the resolution-oracle TEE;
(c) a resolution-rule module executing within the resolution-oracle TEE and configured to apply a deterministic resolution rule, a hash of the deterministic resolution rule being committed at contract listing of the prediction market contract to a publicly verifiable data registry, to the delivered input data sources to produce a resolution outcome; and
(d) an attestation module executing within the resolution-oracle TEE and configured to produce a hardware-attestation quote cryptographically binding the resolution outcome to (i) a measurement of the measured resolution-oracle code base, (ii) cryptographic commitments to the delivered input data sources, (iii) the hash of the deterministic resolution rule, and (iv) the resolution outcome;
wherein the resolution outcome so attested is delivered to a settlement system of the prediction market exchange as a final resolution of the prediction market contract without dependence on a software-based optimistic-oracle dispute channel.

13. The system of claim 1, further comprising an attestation aggregator executing within an additional hardware trusted execution environment and configured to receive hardware-attestation quotes from trusted execution environments operated by two or more prediction-market exchanges, to perform cross-exchange linkage analysis among accounts trading on the two or more prediction-market exchanges, and to produce a cross-exchange attestation record cryptographically binding cross-exchange linkage findings to the received hardware-attestation quotes.

14. The system of claim 1, further comprising an alerting module executing within one of the one or more TEEs and configured to produce, upon production by the surveillance module of a classification of the one or more classifications exceeding a configured severity threshold, a real-time alert to an exchange compliance officer, wherein the real-time alert is accompanied by a hardware-attestation quote produced within the TEE.

15. The method of claim 2, further comprising:
(a) receiving, by a regulator computer system, an exported audit record comprising at least the one or more classifications, the hardware-attestation quote, the hardware-rooted measurement of the measured surveillance code base, and sealed cryptographic commitments to the ingested records;
(b) verifying the hardware-attestation quote against the hardware-vendor attestation service;
(c) instantiating an independent TEE on infrastructure operated by or on behalf of the regulator;
(d) loading the measured surveillance code base into the independent TEE and verifying that a measurement of the loaded code base produced by the independent TEE is equal to the hardware-rooted measurement received in the exported audit record;
(e) supplying, to the independent TEE, input records verified against the sealed cryptographic commitments;
(f) re-executing the measured surveillance code base within the independent TEE on the supplied input records to produce regulator-computed classifications; and
(g) verifying bit-identical equivalence between the regulator-computed classifications and the one or more classifications received in the exported audit record.

16. The method of claim 15, further comprising, upon detection of any divergence between the regulator-computed classifications and the one or more classifications received in the exported audit record, producing, within the independent TEE, a divergence record cryptographically binding together (i) the one or more classifications received in the exported audit record, (ii) the regulator-computed classifications, (iii) the verified measurement of the measured surveillance code base, (iv) the verified input commitments, and (v) a hardware-attestation quote produced by the independent TEE, and committing the divergence record to a tamper-evident audit ledger or a regulator-controlled registry, the divergence record indicating at least one of computational error, non-deterministic execution, inconsistent input reconstruction, and operator interference.

17. The method of claim 2, further comprising producing, within the TEE, a zero-knowledge proof attesting that the one or more classifications were computed on inputs consistent with the cryptographic commitment over the ingested records, without disclosing plaintext of the ingested records to a relying party, and exporting the zero-knowledge proof together with the one or more classifications and the hardware-attestation quote.

18. The method of claim 2, further comprising integrating, into the cryptographic account-linkage fingerprints, at least one know-your-customer attestation and at least one anti-money-laundering attestation, each received from a regulated counterparty in cryptographically signed form, and producing, by a regulatory-export interface coupled to the tamper-evident audit ledger, reporting records configured to support submission to a regulatory reporting endpoint in a format selected from 17 C.F.R. Part 16, 17 C.F.R. Part 17, 17 C.F.R. Part 45, SEC Rule 613 of Regulation NMS, and an equivalent foreign-regulator-designated reporting schema applicable to prediction-market instruments.

19. The non-transitory computer-readable medium of claim 3, wherein the program instructions further cause the TEE to receive hardware-attestation quotes from at least one additional prediction-market exchange operating a corresponding hardware trusted execution environment and to produce, based at least in part on the received hardware-attestation quotes, a cross-exchange attestation record cryptographically binding account-linkage findings across coupled prediction-market exchanges.

20. The non-transitory computer-readable medium of claim 3, wherein the prediction market exchange offers at least one of binary option contracts, event contracts, categorical outcome contracts, and scalar outcome contracts, and wherein the program instructions are applied to orders and executions in the offered contracts under a regulatory framework comprising at least one of a designation as a Designated Contract Market under the Commodity Exchange Act, registration as a securities exchange under the Securities Exchange Act of 1934, and an equivalent foreign regulatory designation.
